(19) United States
(12) Patent Application Publication
(10) Pub. No.: US 2023/0166360 A1
(43) Pub. Date: Jun. 1, 2023

(54) DEVICE AND METHOD FOR JOINING AT LEAST TWO JOINING PARTNERS

(71) Applicant: TRUMPF Laser- und Systemtechnik GmbH, Ditzingen (DE)

(72) Inventor: Felix Zimmermann, Ditzingen (DE)

(21) Appl. No.: 18/102,111

(22) Filed: Jan. 27, 2023

Related U.S. Application Data
(63) Continuation of application No. PCT/EP2021/070234, filed on Jul. 20, 2021.

(30) Foreign Application Priority Data
Jul. 22, 2020 (DE) 10 2020 119 307.6
Sep. 9, 2020 (DE) 10 2020 123 540.2

(51) Int. Cl. B23K 26/57; B23K 26/244; B23K 26/0622; B23K 26/324

(52) U.S. Cl. CPC B23K 26/57; B23K 26/244; B23K 26/0624; B23K 26/324

(57) ABSTRACT

A method for joining two joining partners includes applying a coating to at least one of the two joining partners so as to be arranged between the two joining partners before joining and joining the at least two joining partners to one another using ultrashort laser pulses of a laser beam of an ultrashort pulse laser. At least one joining partner is substantially transparent to the ultrashort laser pulses of the ultrashort pulse laser, and the coating comprises physical properties similar to at least one joining partner and/or a chemical constituent similar to at least one joining partner.

### CROSS REFERENCE TO RELATED APPLICATIONS

This application is a continuation of International Application No. PCT/EP2021/070234 (WO 2022/018069 A1), filed on Jul. 20, 2021, and claims benefit to German Patent Application No. DE 10 2020 119 307.6 filed on Jul. 22, 2020 and to German Patent Application No. DE 10 2020 123 540.2 filed on Sep. 9, 2020. The aforementioned applications are hereby incorporated by reference herein.

### FIELD

The present invention relates to a device and a method for joining at least two joining partners, the at least two joining partners being joined to one another by means of ultrashort laser pulses of a laser beam of an ultrashort pulse laser

### BACKGROUND

For joining at least two joining partners, it is known to impinge on the respective joining partners by means of a laser beam in order in this way to produce a melt in the zone impinged on by the laser beam by way of energy absorption, said melt forming a weld seam between the joining partners after solidification of the melt.

In this case, it is known, for the purpose of joining a transparent joining partner to a nontransparent joining partner or for the purpose of welding two transparent joining partners, to put the focus or the focus zone of the laser beam into the interface or into a region around the common interface of the two joining partners. In this case, the processing laser beam correspondingly passes through one of the transparent joining partners and produces a melt in the region of the interface of the two joining partners.

If ultrashort laser pulses, i.e. laser pulses in the picoseconds range or in the femtoseconds range (e.g. 50 fs-50 ps), are focused into the volume of glass, e.g. quartz glass, then the high intensity at the focus leads to nonlinear absorption processes. Depending on the laser parameters, it is possible in this way to make various material modifications to the glass. If the temporal distance between the successive ultrashort laser pulses is shorter than the thermal diffusion time, then this results in an accumulation of heat or an increase in temperature in the glass in the focus region. With each of the successive pulses, the temperature can then be increased to the melting point of the glass and ultimately locally melt the glass.

In the context in which joining partners are joined, the fracture toughness of the later weld seam may firstly be defined by the laser parameters. Secondly, the stability of the connection also depends on the materials and the material composition of the joining partners.

US 2015/0027168 A1 discloses inserting a coating between the joining partners, positioning the laser focus in the coating, and initiating a joining process by way of heating the coating. This has the disadvantage that the joining behavior of the joining partners is poorly controllable by way of the method.

### SUMMARY

In an embodiment, the present disclosure provides a method for joining two joining partners that includes applying a coating to at least one of the two joining partners so as to be arranged between the two joining partners before joining and then joining the at least two joining partners to one another using ultrashort laser pulses of a laser beam of an ultrashort pulse laser. At least one joining partner is substantially transparent to the ultrashort laser pulses of the ultrashort pulse laser, and the coating comprises physical properties similar to at least one joining partner and/or a chemical constituent similar to at least one joining partnerglass.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic illustration of the method with quasi-nondiffractive beams;

FIG. 2 shows a schematic illustration of the method with Gaussian beams;

FIG. 3A, 3B, 3C, 3D show a schematic illustration of the quasi-nondiffractive beams;

FIG. 4A, 4B show a schematic illustration of the temporal modulation of the laser pulses; and

FIG. 5 shows a schematic illustration of the device for carrying out the method.

### DETAILED DESCRIPTION

An aspect of the present invention is to provide an improved method for joining at least two joining partners, and a corresponding device for carrying out the method.

Accordingly, a method for joining at least two joining partners is proposed, the at least two joining partners being joined to one another by means of ultrashort laser pulses of a laser beam of an ultrashort pulse laser, at least one joining partner being substantially transparent to the ultrashort laser pulses of the ultrashort pulse laser, and before the joining, a coating being applied to at least one of the joining partners and the coating being arranged between the joining partners, wherein the coating comprises physical properties similar to at least one joining partner and/or a chemical constituent similar to at least one joining partner.

In this case, the coating results in an improvement in the joining connection. In particular, the fracture toughness of the connection of the joining partners joined with the coating, with the same process parameters, can be greater than the fracture toughness of the connection if it had been joined without the coating.

In this case, the joining laser makes available the ultrashort laser pulses, i.e. laser pulses in the picoseconds range or femtoseconds range. The ultrashort laser pulses move on a trajectory determined by an optical unit of the joining laser, the so-called laser beam. An ultrashort laser pulse of the joining laser is also called a joining pulse.

The laser can also make available pulse trains, so-called bursts, composed of ultrashort laser pulses, each burst comprising the emission of a plurality of laser pulses. In particular, so-called GHz bursts can also be provided here, the repetition rate of the individual laser pulses having a magnitude of up to 50 GHz, for example.

Substantially transparent means that the at least one joining partner has a transparency of more than 50% to the wavelength of the laser beam. The transparency of the at least one joining partner has the advantage that the joining laser can be focused through the transparent joining partner, with the result that the joining region can be localized at the interface of both joining partners. In the case of two transparent joining partners, both directions of incidence are accordingly possible.

The first joining partner can be transparent, for example, and the second joining partner can be opaque. By way of example, the first joining partner can consist of quartz glass, and the second of aluminum. However, it is also possible for both joining partners to be transparent.

The coating is applied, for example by vapor deposition, to at least one of the joining partners before the joining process, with the result that the coating is fixedly connected to the joining partner. However, it is also possible to apply the coating for example by spraying or spreading or for example by spinning in a so-called rotary coating process and baking it. It is also possible, in particular, for the coating to be applied only locally on the joining partner, the coating being applied only where a welding connection of the joining partners is intended to arise in the process that follows. This can be effected for example by means of a masking of the joining partner, such that for example the coating is arranged only on the unmasked points of the joining partner.

The at least one joining partner with the coating is subsequently oriented relative to the other joining partner such that the coating makes contact with the other joining partner. The coating is thus arranged between the joining partners. In other words, the coating then lies in the interface arranged between the two joining partners. In this case, the interface lies in the joining region.

Similar physical properties of the coating and of the at least one joining partner may comprise for example a similar transmission of the laser wavelength, similar melting point, similar thermal expansion, similar crystal structure or lattice structure, etc.

Similar chemical constituents of the coating of the at least individually associated joining partner may comprise for example a similar chemical composition, in particular elements of the same chemical group having similar electronegativity, similar chemical compounds and in particular the same elements.

Accumulation of heat takes place in the joining region as a result of progressive absorption of the ultrashort laser pulses, provided that the pulse rate of the joining beam is greater than the rate of heat dissipation by material-specific heat transfer mechanisms, in particular by thermal diffusion.

As a result of the rising temperature in the material of the at least first joining partner from joining pulse to joining pulse, the melting point of the material of the joining partner can thus ultimately be attained, which results in local melting of the material of the first joining partner into which the joining beam enters. In particular, the coating can also be melted in the process.

Joining region is understood to mean that region of the joining partners and of the coating in which the ultrashort laser pulses are introduced and in which the material is melted. Alternatively, the totality of the locally melted material in the joining region may also be referred to as a melt bubble. Irrespective of the designation, the melt that arises can bridge the common interface of the joining partners and permanently connect the joining partners to one another upon cooling. In this case, the molten constituents of the joining partners and the coating are mixed together and an integral bond is subsequently formed. In this case, in particular, the chemical and physical structure of the joining partners may also change, with the result that a particularly stable joining modification is formed. In this case, joining modification denotes the cooled melt which connects the joining partners to one another, or produces the weld seam.

In order to melt the material in the joining region, for example between 2 and 10 ultrashort laser pulses and/or bursts can be introduced into the material and progressively absorbed. This plurality of ultrashort laser pulses and/or bursts are introduced into the material for the intended material processing, viewed spatially, in each case in a laser spot, that is to say in the spatial extent of the respective focus region of the laser in the material.

The number of the laser pulses introduced at a single location is referred to as a pulse overlap. The pulse overlap can be considered to be a measure of the accumulation of heat.

For example, if no advance takes place and all pulses are introduced at the same location of the material, then the pulse overlap is at a maximum. By contrast, if an advance takes place between the material and the laser spot, the pulse overlap can decrease depending on the ratio of pulse frequency (repetition rate) and advancing rate. If the advancing rate is too high, an overlap of the laser spots in the material no longer takes place and the laser spots lie next to one another.

The number of ultrashort laser pulses and/or bursts per location in the material is given by the product of the laser spot size SG and the repetition rate P per advancing rate VG. In other words, the pulse overlap is given for example by SG*P/VG. In this case, the pulse overlap describes the spatial region over which the ultrashort laser pulses and/or bursts are emitted into the material.

In this case, the average laser power can be between 0.5 W and 50 W, the average power being defined as the product of the pulse energy of the individual pulses, if appropriate the number of pulses in the burst, and the repetition rate of the pulses. Enough laser power to melt the material is thus made available.

At least one joining partner can be a metal or a semiconductor or an insulator or a combination thereof, in particular can be a glass ceramic or a crystal or a polymer.

By way of example, the material can comprise a steel alloy and/or a carbon compound and/or an iron compound and/or an aluminum compound and/or a calcium fluoride compound and/or a silicon compound, in particular a silicon oxide compound, or a copper compound.

By way of example, the material can be a glass, for example a quartz glass, or a silica glass, or a Corning Eagle glass. By way of example, the material can be steel. By way of example, the material can be copper or calcium fluoride.

The coating can comprise at least one chemical constituent which is present in one of the joining partners.

A coating of a joining partner which comprises a constituent present in one of the joining partners can have the effect that the atoms of the surface of the joining partner are then exposed to other binding forces at the interface between coating and volume material of the joining partner. This can have the effect that the mixing process in the melt bubble proceeds particularly advantageously, for example a homogeneous mixture of the joining partners and the coating arises and, as a result, a particularly stable joining connection or weld seam arises upon cooling.

By way of example, before the joining of steel and sapphire (Al₂O₃) an aluminum coating can be applied to one of the joining partners. By virtue of aluminum being present at least in sapphire, the aluminum layer functions for example as a mediator and exchange layer during the actual joining process.

The laser beam can have a focus zone elongated in the beam direction, in which case the focus zone can overlap the coating, and the focus zone can penetrate through the two interfaces of the joining partners that face one another, and/or the focus zone can penetrate through at least one of the two interfaces of the joining partners that face away from one another.

By means of a focus zone elongated in the beam direction, the average power is distributed over a part of the layer system thickness, i.e. can also extend into the volume of the material of one or both joining partners. Since overall a larger region is heated, high thermal gradients and pressure gradients in and counter to the direction of beam propagation are reduced, such that cracking can be prevented as a result. In addition, it is also possible to melt and thus join together a larger region of the layer system. This results in stabler joining connections, in particular. A further advantage of an elongated focus zone is the increased tolerance vis-à-vis position deviations. By way of example, it is possible for the joining partners not to bear one on top of another in an exactly plane manner, but rather to enclose a gap. It may also be the case that both joining partners have a certain surface roughness. These spacings can be bridged by an elongated focus zone.

By virtue of the focus zone overlapping the coating, it is possible, in particular, for the laser energy likewise to be introduced into the coating and for the coating thereby to be melted.

The fact that the focus zone penetrates through the two boundary surfaces of the joining partners that face one another ensures that the laser energy can be introduced into both joining partners, such that both joining partners can be melted. This can result in an improvement in the connection since the joining partners mix together better in the melt bubble as a result. In particular, the boundary surfaces of the joining partners that face one another are the boundary surfaces that adjoin the coating.

The fact that the focus zone penetrates through at least one boundary surface of the joining partners that faces away, i.e. penetrates through in particular an boundary surface of the joining partners which faces away from the coating, i.e. which in particular is not in contact with the coating, ensures that the joining partner is heated across a larger region. This can have the effect that the joining partner also melts in a larger region. In particular, this can also have the effect, however, that the thermal gradient that arises during joining extends across a larger area and, as a result, overall compressive and tensile stresses in the joining partner are locally reduced and/or redistributed. Cracking, in particular, can be prevented as a result.

The laser beam can locally melt at least one of the joining partners, preferably locally melt at least one of the joining partners and the coating, or locally melt both joining partners, particularly preferably locally melt both the joining partners and the coating

The fact that only one joining partner melts ensures that a melt bubble arises which can bridge the interface of the joining partners, thus giving rise to a connection of the two joining partners.

If one joining partner and the coating are locally melted, this ensures that the material of the joining partner mixes together better with the coating and a stabler joining connection can be established with the other joining partner.

If both joining partners locally melt, this ensures that the materials of the joining partners mix together, with the result that an even stabler joining connection of the two joining partners can be produced.

If both the joining partners and the coating locally melt, the joining partner material also mixes together with the coating material, with the result that a particularly stable joining connection of the two joining partners can be produced.

The laser beam can be a quasi-nondiffractive laser beam, preferably a Gaussian-Bessel beam.

Nondiffractive beams satisfy the Helmholtz equation:

∇²U(x,y,z)+k²U(x,y,z)=0

and have a clear separability into a transverse and a longitudinal dependence of the form

U(x,y,z)=Uₜ(x,y)exp(ik_{z}z)

In this case, k=ω/c is the wave vector with its transverse and longitudinal components k²=k_{z}²+kₜ², and Uₜ(x,y) is an arbitrary complex-valued function that is dependent only on the transverse coordinates x, y. The z-dependence in the beam propagation direction in U(x,y,z) leads to a pure phase modulation, and as a result the associated intensity I of the solution is propagation-invariant or nondiffractive:

I(x,y,z)=|U(x,y,z)|²=I(x,y,0).

This approach provides different classes of solutions in different coordinate systems, for example Mathieu beams in elliptic-cylindrical coordinates or Bessel beams in circular-cylindrical coordinates.

Experimentally it is possible to realize a multiplicity of nondiffractive beams in a good approximation, that is to say quasi-nondiffractive beams. In contrast to the theoretical construct, these merely carry finite power. Just as finite is the length L of the propagation invariance of these quasi-nondiffractive beams.

Furthermore, we define as transverse focus zone or diameter of the beam profile in quasi-nondiffractive beams d^{ND}₀ the transverse dimensions of local intensity maxima as the shortest distance between directly adjoining, opposite intensity minima.

The longitudinal extent of the focus zone in the beam propagation direction of these almost propagation-invariant intensity maxima gives the characteristic length L of the quasi-nondiffractive beam. This characteristic length is defined by way of the intensity drop to 50%, proceeding from the local intensity maximum in a positive and negative z-direction, that is to say in the propagation direction.

A quasi-nondiffractive beam is present exactly if for d^{ND}₀≈d^{GF}₀, that is to say similar transverse dimensions, the characteristic length L distinctly exceeds the Rayleigh length of the associated Gaussian focus, for example if L>10z_{R}.

As a subset of the quasi-nondiffractive beams, quasi-Bessel beams or Bessel-like beams, here also referred to as Bessel beams, are known. In this case, the transverse field distribution Uₜ(x,y) in the vicinity of the optical axis obeys to a good approximation a Bessel function of the first kind of order n. A further subset of this class of beams is the Bessel-Gaussian beams, which are widely used owing to the simple generation thereof. The illumination of an axicon in a refractive, diffractive or reflective embodiment with a collimated Gaussian beam thus enables the shaping of the Bessel-Gaussian beam. In this case, the associated transverse field distribution in the vicinity of the optical axis obeys to a good approximation a Bessel function of the first kind of the order 0, which is enveloped by a Gaussian distribution. Bessel-Gaussian beams thus have a radially symmetrical beam cross-section, such that the intensity of the laser beam perpendicular to the direction of beam propagation depends only on the distance with respect to the optical axis. This has the advantage that the properties of the joining connection are independent of the weld seam geometry.

As a result, a significantly larger focus position tolerance can be achieved during joining. Consequently, for example, the influence of local undulations in the glass and the focus alignment is reduced. Accordingly, it can be advantageous to use a quasi-nondiffractive beam, in particular a Bessel beam, for joining purposes since, by this means, inter alia, larger gaps can be bridged and the focus position tolerance thus becomes larger. The proposed method can thus be used in a broader area of application—for example even if the workpieces to be joined do not bear one on top of another in a perfectly plane manner in the region of the desired weld seam and there is accordingly a gap between the workpieces.

Typical Bessel-Gaussian beams which can be used for joining have for example diameters of the central intensity maximum on the optical axis of d^{ND}₀=2.5 μm. A Gaussian focus where d^{ND}₀≈d^{GF}₀=2.5 μm, by contrast, is distinguished by a focus length in air of only z_{R}≈5 μm at λ=1 μm. In these cases which are relevant for material processing, L>>10z_{R} may even apply.

Moreover, focus zones having a length of between 150 μm and 500 μm are preferred for the joining, a length of 300 μm being particularly preferred for producing large linking cross-sections or for producing wide weld seams.

Before the joining, the coating can be applied to one of the joining partners, the coating comprising at least one constituent which is present in the other joining partner. In particular, the coating can also comprise constituents which are present in both joining partners.

As a result, a particularly stable connection can be produced between the joining partners.

By way of example, an aluminum layer (Al) can be applied to a joining partner consisting of sapphire (Al₂O₃) and can then be joined to a joining partner composed of a steel alloy (comprising Fe, C and Al).

By way of example, a layer composed of amorphous silicon oxide (SiO₂) can be applied to a joining partner composed of calcium fluorite (CaF₂) and can be joined to a joining partner composed of quartz glass (SiO₂).

By way of example, a layer composed of copper (Cu) can be applied to a joining partner composed of Corning Eagle glass (for example alkaline earth boro-aluminosilicate) and can be joined to a joining partner composed of copper (Cu).

By way of example, a layer composed of amorphous silicon oxide (SiO₂) can also be applied to a joining partner composed of copper (Cu) and can be joined to a joining partner composed of Corning Eagle glass.

The coating can be thicker than three monolayers of the material of the coating.

This has the advantage that the coating can be applied to the joining partner over an extensive area. In particular, this means that no holes arise in the coating, and so the joining partner can be joined equally well at all points.

In this case, a monolayer is a layer having a thickness of exactly one atom or one molecule of the material of the coating. In this case, a three monolayer thick layer has a thickness of three atoms or three molecules of the material of the coating.

The coating can be applied to one of the joining partners by means of physical vapor deposition, chemical vapor deposition, sputtering or some other evaporation method.

By means of one of these known methods mentioned above, it is possible to achieve particularly uniform layer growth on the joining partner. In particular, these methods are also usable on an industrial scale.

In all the methods mentioned above, a substrate containing the chemical constituents of the coating is evaporated, the vapor being deposited onto the adjoining partner and the coating forming on the surface of the joining partner.

The absorption of the laser beam by the coating can be small, and can preferably be less than 50%, and/or the absorption of the laser beam by the coating can be smaller than the absorption by at least one joining partner

This has the advantage that the laser beam can be at least partly transmitted through the coating and can reach the other joining partner in order to heat the other joining partner. What can thereby be achieved, in particular, is that both joining partners are melted in order thus to achieve a stable connection of the two joining partners.

However, there may be a finite absorption of the laser beam in the coating, with the result that the coating is also heated and melted. What is thereby achieved is that the materials of the two joining partners and the coating mix together in the melt bubble and a particularly stable connection of the joining partners is thus achieved.

The wavelength of the ultrashort laser pulses can be between 200 nm and 5000 nm, and can preferably be 1030 nm, and/or the pulse duration of a laser pulse can be between 50 fs and 10 ps, and can preferably be 400 fs, and/or a plurality of laser pulses can be emitted in a pulse train, the repetition rate of the laser pulses in the pulse train being between 1 kHz and 50 GHz, and/or individual laser pulses can be emitted, the repetition rate of the individual laser pulses being between 1 kHz and 50 MHz, and/or the numerical aperture of the focused laser beam can be between 0.1 and 0.7, and/or the fluence at the focus can be greater than 0.01 J/cm², and/or the raw beam diameter can preferably have a magnitude of 5 mm, and/or the average laser power can be between 0.5 W and 50 W.

These parameters allow the joining process to be optimized for numerous material combinations.

By way of example, the wavelength of the ultrashort laser pulse can be 1030 nm, in which case the pulse duration of an individual pulse has a magnitude of 400 fs, two pulses are emitted per burst, the spacing of the pulses is 20 ns, which corresponds to a pulse repetition rate of 50 MHz, the bursts have a repetition rate of 200 kHz, the numerical aperture is 0.25, the fluence at the focus is between 5 and 100 J/cm², for example 75 J/cm², and the average laser power is 5 W.

The laser pulse energy can be temporally modulated from pulse to pulse, the modulation rate being between 100 Hz and 10 kHz, the modulation shape preferably being sin²-shaped or triangular.

Temporally modulated means that the pulse energy is varied during a modulation duration, the modulation duration being given by the inverse modulation rate. In this case, the modulation rate indicates the time scale on which the modulation shape is repeated. In particular, a modulation of the pulse energy means that the pulse energy can become larger or smaller during the modulation duration. In this case, the modulation shape indicates what mathematical function the pulse energy follows during the modulation duration.

The modulated pulse energy from pulse to pulse has the effect that there are times when less pulse energy is introduced into the joining partner(s) and a temperature relaxation can take place, or there are times when more energy can be introduced than without the modulation. Cracking can thus be controlled and/or avoided.

By way of example, a temporal modulation can be achieved by the intensity of the joining pulses being varied. By way of example, a strong joining pulse can be emitted, followed by two joining pulses having half the intensity. However, the temporal modulation also includes the laser then emitting again a strong joining pulse followed by two weakened joining pulses.

The ultrashort laser pulses of the laser beam can be introduced into the material together with a further laser beam, the further laser beam being a continuous-wave laser beam or carrying pulses having a pulse length of between 1 ns and 100 μs.

By virtue of a further laser beam impinging on the material of the joining partner(s), the temperature in the material is increased, such that the thermal gradient during the joining of the joining partners is smaller. Cracking can be prevented as a result.

The laser beam and the joining partners can be moved and/or positioned relative to one another.

Moved relative to one another can mean that either the laser beam or the layer system or both the laser beam and the layer system is/are moved. What can be achieved as a result is that the laser beam introduces joining connections at different locations of the joining partners. In particular, it is thereby possible to produce a continuous weld seam between the two joining partners.

In this case, the movement can take place with an advance, in which case laser pulses or laser pulse trains can be introduced into the joining partners continuously during the advance. A positioning of the joining partners relative to the laser beam consists in the focus zone of the laser beam being introduced into the desired penetration depth and into the desired location.

The object stated above is furthermore achieved by means of a device for joining at least two joining partners having the features of claim 16. Advantageous developments of the device are evident from the dependent claims, the present description, and the figures.

Accordingly, a device for joining two joining partners is proposed, comprising an ultrashort pulse laser configured to make available a laser beam carrying ultrashort laser pulses, an advancing device configured to shift and/or position the joining partners and the laser beam relative to one another, a focusing optical unit configured to generate an intensity boost of the laser beam, the focusing optical unit comprising a beam shaping optical unit configured to impose on the laser beam a focus zone elongated in the direction of beam propagation, the at least two joining partners being joined to one another by means of ultrashort laser pulses of the laser beam of the ultrashort pulse laser, at least one joining partner being substantially transparent to the ultrashort laser pulses of the ultrashort pulse laser, and before the joining, a coating being applied to at least one of the joining partners and the coating being arranged between the joining partners, the focus zone overlapping the coating, and the focus zone penetrating through the two boundary surfaces of the joining partners that face one another, and/or the focus zone penetrating through at least one of the two boundary surfaces of the joining partners that face away from one another, wherein the coating comprises physical properties similar to at least one joining partner and/or a chemical constituent similar to at least one joining partner.

An advancing device is a device that is movable on at least two spatial axes and can be for example an XY-table or an XYZ-table. The advancing device can have a securing device, for example, on which the joining partners can be fixed. Fixing can be realized by adhesive bonding or clamping, for example. However, fixing can also function by way of a negative air pressure by means of a suction device.

Furthermore, an advancing device can be moved or displaced in an automated manner, or in a motorised manner with an advance. In this case, the advance is a movement at an advancing rate, the advance taking place along an advancing trajectory.

By virtue of the advancing device moving the material relative to the laser beam, the laser beam is guided over the material along an advancing trajectory, whereby it is possible to process and in particular to join the material at the locations of the advancing trajectory.

The beam shaping optical unit can comprise a spatial light modulator or a diffractive optical element or an axicon or an acousto-optical deflector. A beam shaping optical unit here can in particular also comprise an objective lens for focusing the laser beam.

A spatial light modulator makes it possible to fan out the process beam to a predefined geometry, for example round, square or star-shaped A diffractive element likewise allows the process beam to be spatially fanned out to a predefined geometry. In this case, and axicon is a conically ground optical element which can impose a quasi-nondiffractive beam profile on a Gaussian laser beam as the latter passes through.

An acousto-optic deflector makes it possible to deflect the process beam periodically over time, with the result that, in particular, Lissajous-figure-shaped heating patterns can be generated in the interface, with the result that a larger area is heated. The deflection by means of an acousto-optic deflector additionally allows a randomized movement pattern, so-called random access scanning, thereby enabling an arbitrary heating pattern to be scanned rapidly.

The focusing optical unit here can comprise in particular an optical system which enables a magnifying or reducing imaging of the beam profile into the joining partners. In particular, by way of the lens system, the focus zone can be displaced in or counter to the direction of beam propagation in order thus to position the focus zone in the interface layer of the two joining partners and to enable the laser pulse energy to be introduced into the interface layer.

The focusing optical unit can comprise a distance sensor, preferably can comprise a confocal distance sensor, which is configured to regulate the distance and/or the positioning of the joining partners relative to a reference point in space. The focusing optical unit can comprise a camera configured to regulate the establishing of the laser focus.

This makes it possible, in particular, for the focus zone to be able to be positioned in the interface layer of the two joining partners. In addition, it is thus also possible to compensate for unevennesses on the material surface, such that the focus zone can also be guided along a skew plane, provided that the joining partners were mounted not exactly plane with respect to one another or skew. As a result, the tolerance range for the joining process is increased, thereby enabling stable joining connections.

Preferred exemplary embodiments are described below with reference to the figures. In this case, elements that are the same, similar or have the same effect are provided with identical reference signs in the different figures, and a repeated description of these elements is dispensed with in some instances, in order to avoid redundancies.

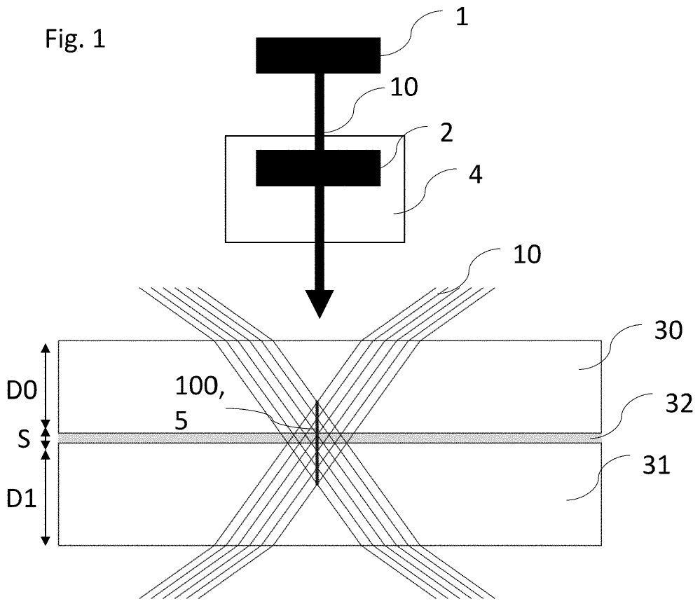

FIG. 1 schematically shows a cross-section of two joining partners 30, 31 to be joined. A coating 32 is applied on one of the joining partners 30, 31, the joining partners 30, 31 being oriented in particular such that the coating 32 is arranged between the two joining partners 30, 31. In this case, each joining partner 30, 31 has a thickness D0, D1.

In this case, the coating 32 has physical and/or chemical properties similar to those of at least one of the joining partners 30, 31.

By way of example, the coating 32 can comprise a constituent in the form of a chemical element and/or molecule which is present in the joining partner 31. In particular, the coating 32 can be arranged on the joining partner 30 and have a thickness S which is greater than three monolayers of the material of the coating. This ensures a continuous coating 32 on the joining partner 30. In this case, the coating 32 may have been applied to the joining partner 30 in particular by means of a vapor deposition method, such as sputtering, for example.

The ultrashort pulse laser 1 makes available the ultrashort laser pulses of the laser beam 10. These can be introduced in the form of individual laser pulses or in the form of pulse trains into the joining partners 30, 31 and the coating 32. In this case, the laser wavelength can be between 200 nm and 5000 nm and/or the repetition rate of the individual pulses can be between 100 Hz and 50 Hz and/or the repetition rate of the pulses in a pulse train can be between 1 MHz and 50 GHz and/or the number of pulses per pulse train can be between 2 and 5 and/or the laser pulse duration can be between 10 fs and 50 ps. In particular, the average laser power can be between 0.5 W and 50 W.

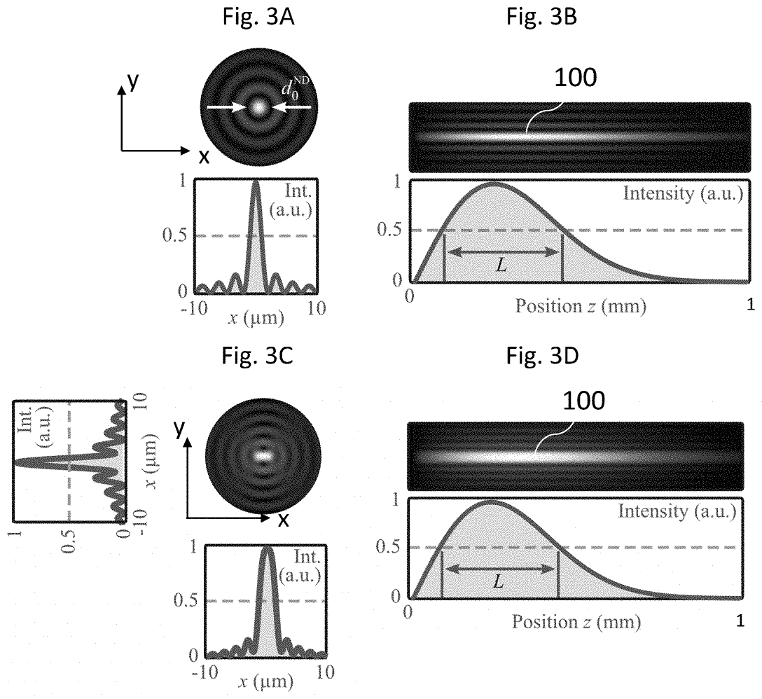

The laser beam is guided through a focusing optical unit 4 comprising a beam shaping optical unit 2. In this case, the beam shaping optical unit 2 can be for example an axicon or a diffractive optical element. The beam shaping optical unit 2 imposes on the laser beam 10 of the ultrashort pulse laser a quasi-nondiffractive beam shape, for example a Bessel beam shape or a Bessel-Gaussian beam shape, as shown in greater detail in FIG. 3. In particular, this causes the laser beam 10 to have an elongated focus zone 100.

The quasi-nondiffractive laser beam 10 is focused by a suitable focusing optical unit 4 such that the focus zone 100, i.e. the region in which the intensity of the laser beam 10 is boosted, coincides approximately with the coating 32. By way of example, the fluence in the focus zone can be more than 0.01 J/cm². A focusing makes it possible here to determine in particular the penetration depth of the focus zone 100 relative to the first joining partner 30.

The focus zone 100 overlaps the coating 32 and penetrates through the two boundary surfaces of the joining partners that face one another. In particular, this means that the focus zone 100 lies at least partly in the volume material of the joining partners 30, 31, such that energy of the laser 1 can be deposited into both joining partners 30, 31. However, the focus zone 100 does not penetrate through the sides of the joining partners 30, 31 that face away from the coating 32. In particular, the focus zone 100 thus lies completely within the two joining partners 30, 31, such that the focus zone 100 in the direction of beam propagation is shorter than the sum of the thicknesses D0, D1 of the joining partners 30, 31 This ensures that the ultrashort laser pulses of the ultrashort pulse laser 1 introduce the joining modification 5 within the joining partners 30, 31 and, in particular, no modification of the outer surfaces of the joining partners 30, 31 takes place.

In order to cause the laser beam 10 to overlap the coating 32, the first joining partner 30 in the direction of beam propagation must be transparent to the wavelength of the laser 1. Both joining partners 30, 31 can also be transparent to the wavelength of the laser 1, such that the laser beam 10 can also be focused through the joining partner 31 in the direction of beam propagation. In particular, it may be the case that the coating 32 absorbs less than 50% of the laser energy of the laser beam 10, such that in the direction of beam propagation the laser beam 10 is transmitted through the joining partner 30, is subsequently transmitted through the coating 32 and is finally transmitted into the joining partner 31. This ensures, in particular, that all the materials involved, namely the two joining partners 30, 31 and the coating 32, can be melted.

For this purpose, the joining partners 30, 31 can comprise a metal and/or a semiconductor and/or an insulator or a combination thereof; in particular, the joining partners can comprise a glass ceramic or a crystal or a polymer.

By way of example, the joining partner 31 can consist of sapphire (Al₂O₃), an aluminum layer (Al) can be arranged on the joining partner 31 and the joining partner 30 can consist of a steel alloy (comprising Fe, C and Al).

By way of example, the joining partner 30 can consist of calcium fluorite (CaF2), a layer composed of amorphous silicon oxide (SiO2) can be arranged on the joining partner 30 and the joining partner 31 can be a quartz glass (SiO2).

Laser pulses are progressively absorbed in the focus zone 100 in such a way that the material of the joining partners 30, 31 and of the coating 32 melts and bonds with the respective other joining partner 30, 31 across the interface 32. However, it is also possible for only one of the joining partners 30, 31 to melt or for only one of the joining partners 30, 31 and the coating 32 to melt, or for both joining partners 30, 31 to melt, or for both joining partners 30, 31 and the coating 32 to melt. As soon as the melt cools, a permanent connection of the two joining partners 30, 31 arises.

In other words, the two joining partners 30, 31 are joined to one another in the region in which the focus zone 100 is positioned. This region in which the melting and bonding of the materials and also the subsequent cooling of the melt take place and in which the actual joining accordingly takes place is also referred to as joining region. The cooled melt and material connection of the joining partners 30, 31 form the joining modification 5 or the weld seam. In particular, an improvement in the connection is brought about by the coating 32 in this case since, for example, the mixing processes proceed particularly advantageously in the melt. In this case, the coating 32 functions as a kind of adhesion promoter between the joining partners 30, 31.

In particular, the fracture toughness of the connection of the joining partners 30, 31 joined with the coating, with the same process parameters, is greater than the fracture toughness of the connection of the joining partners 30, 31 joined without the coating.

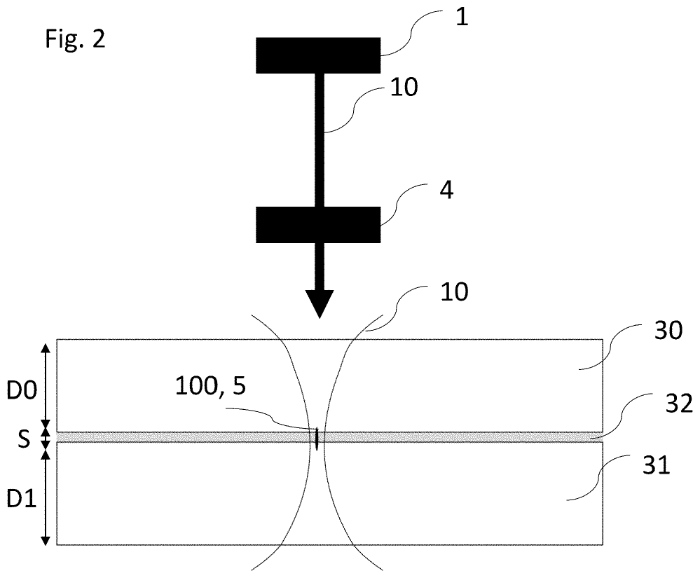

FIG. 2 shows the same set-up as in FIG. 1, a Gaussian laser beam 10 being made available by focusing optical unit 4. In particular, it is thereby possible to attain a symmetrical Gaussian beam profile, as a result of which the introduced joining modifications 5 are radially symmetrical and hence do not cause any stress peaks in the joining partners 30, 31. In particular, the Gaussian beam profile nevertheless exhibits a slightly elongated focus zone 100, which both overlaps the coating 32 and penetrates through the boundary surfaces of the joining partners 30, 31 that face one another.

FIG. 3A a shows the intensity profile and beam cross-section of a quasi-nondiffractive laser beam 10. In particular, the quasi-nondiffractive beam 10 is a Bessel-Gaussian beam. The Bessel-Gaussian beam has a radial symmetry in the beam cross-section in the x-y plane, such that the intensity of the laser beam depends only on the distance with respect to the optical axis. In particular, the transverse beam diameter d^{ND}₀ has a magnitude of between 0.25 μm and 10 μm.

FIG. 3B shows the longitudinal beam cross-section, i.e. the beam cross-section in the direction of beam propagation. The beam cross-section has an elongated focus zone 100 having a size of approximately 300 μm. Therefore, the focus zone 100 in the direction of propagation is significantly larger than the beam cross-section in the x-y plane, with the result that an elongated focus zone 100 is present.

FIG. 3C shows, analogously to FIG. 3A, a Bessel beam having a non-radially symmetrical beam cross-section. In particular, the beam cross-section appears stretched, almost elliptic, in the y-direction.

FIG. 3D shows the longitudinal focus zone 100 of the Bessel beam, which again has an extent of approximately 3 μm. The Bessel beam, too, accordingly has a focus zone 100 elongated in the direction of beam propagation.

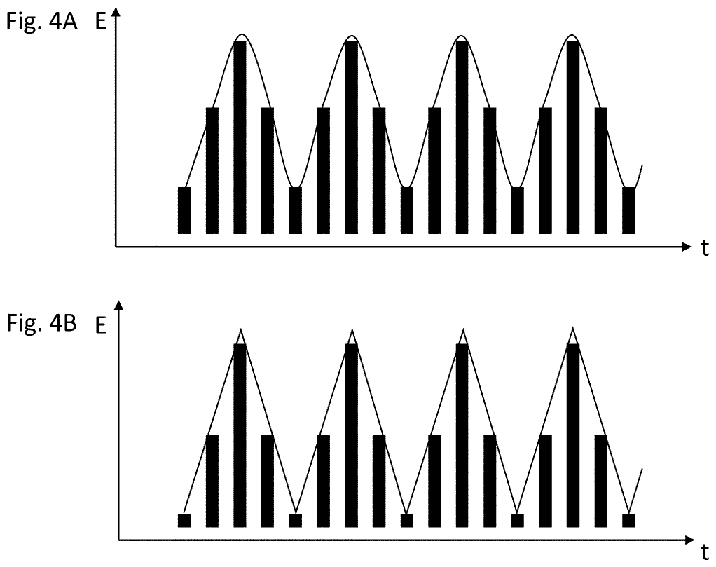

FIG. 4A shows a temporal modulation of the laser pulse energy from pulse to pulse. In particular, the modulation rate in this case can be between 100 Hz and 10 kHz. The modulation shape is sine²-shaped, and so the successive pulses deviate from one another in terms of their pulse energy in accordance with the sine function. Analogously thereto, FIG. 4B shows a temporal modulation of the laser pulse energy from pulse to pulse where the modulation shape here is triangular. In this case, the laser pulse energy follows a triangular function.

The modulation shapes shown make it possible that the joining partners 30, 31 can easily cool between the introduction of the pulses with the maximum power illustrated, with the result that cracking in the material of the joining partners 30, 31 is prevented.

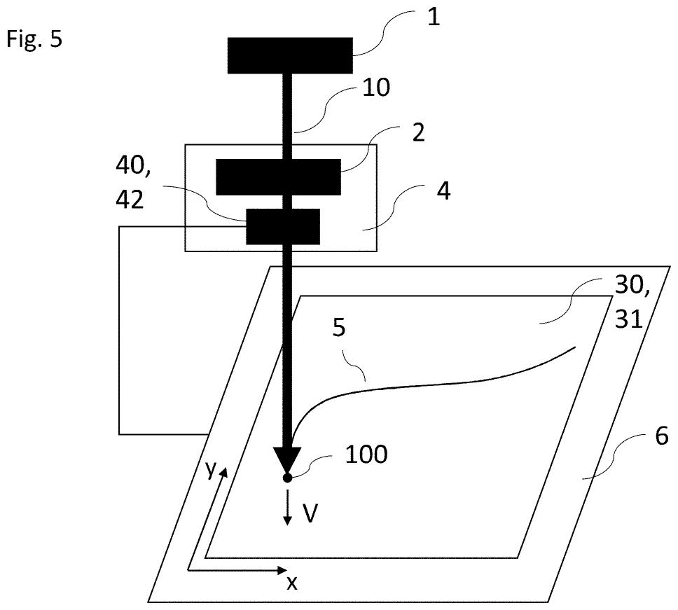

FIG. 5 schematically shows a device for carrying out the method. In particular, an advancing device 6 is illustrated, on which the joining partners 30, 31 are mounted. In this case, the advancing device 6 is an XY-table, such that joining partners 30, 31 mounted thereon can be moved in the XY-direction. The advancing device 6 moves the joining partners 30, 31 away beneath the laser beam 10 with an advance V, although the laser 1 emits laser pulses with repetition rate. In particular, the focus zone 100 is thus moved and/or positioned relative to the joining partners 30, 31. The emission of the laser pulses accordingly gives rise to a continuous weld seam 5 which fixedly connects the 2 joining partners 30, 31 to one another.

The focusing optical unit 4 of the device can comprise a distance sensor 40, which measures the distance of the joining partners 30, 31 relative to a reference point in space. In particular, the focusing optical unit can also comprise a camera 42, by means of which the establishing of the laser focus can be regulated. Both the camera 42 and the distance sensor 40 can be connected to the advancing device 6 and also to the focusing optical unit 4, with the result that it is possible to couple the distance values of the distance sensor 40 and respectively the focus values of the camera 42 to the focusing optical unit 4 and also the advancing device 6. This ensures that the focus zone 100 can always be positioned at the desired point in the joining partners 30, 31. In particular, it is thereby possible to avoid undesired melting of the joining partners 30, 31 for example at the surface. Moreover, it is thereby possible to produce a continuous welded seam in a desired geometry between the joining partners 30, 31.

Insofar as applicable, all individual features presented in the exemplary embodiments can be combined with one another and/or interchanged, without departing from the scope of the invention.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Laser
10 Laser beam
100 Focus zone
2 Beam shaping optical unit
30 Joining partner
31 Joining partner
32 Coating
4 Focusing optical unit
40 Distance sensor
42 Camera
5 Joining modification
6 Advancing device
D0 Thickness of the joining partner
D1 Thickness of the joining partner
S Thickness of the coating

1. A method for joining two joining partners, comprising:
applying a coating to at least one of the two joining partners so as to be arranged between the two joining partners before joining;
joining the at least two joining partners to one another using ultrashort laser pulses of a laser beam of an ultrashort pulse laser, wherein at least one joining partner is substantially transparent to the ultrashort laser pulses of the ultrashort pulse laser, and
wherein the coating comprises physical properties similar to at least one joining partner and/or a chemical constituent similar to at least one joining partner.

2. The method as claimed in claim 1, wherein at least one joining partner is a metal or a semiconductor or an insulator or a combination thereof.

3. The method as claimed in claim 1, wherein the coating comprises at least one chemical constituent which is present in a joining partner.

4. The method as claimed in claim 1, wherein the laser beam has a focus zone elongated in a beam direction, wherein the joining includes disposing the focus zone so as to overlap the coating, and to penetrate through two boundary surfaces of the joining partners that face one another, and/or to penetrate through at least one of two boundary surfaces of the joining partners that face away from one another.

5. The method as claimed in claim 1, wherein the laser beam locally melts at least one of the joining partners, or locally melts both joining partners.

6. The method as claimed in claim 1, wherein the laser beam is a quasi-nondiffractive laser beam.

7. The method as claimed in claim 1, wherein the coating comprises at least one constituent present in the other joining partner.

8. The method as claimed in claim 1, wherein the coating is thicker than three monolayers of the material of the coating.

9. The method as claimed in claim 1, wherein the coating is applied to one of the joining partners using physical vapor deposition, chemical vapor deposition, sputtering or another evaporation method.

10. The method as claimed in claim 1, wherein a fracture toughness of a connection of the joining partners joined with the coating, with the same process parameters, is greater than a fracture toughness of a connection of the joining partners joined without the coating.

11. The method as claimed in claim 1, wherein an absorption of the laser beam by the coating is small and/or an absorption of the laser beam by the coating is smaller than an absorption by at least one joining partner.

12. The method as claimed in claim 1, wherein
a wavelength of the ultrashort laser pulses is between 200 nm and 5000 nm and/or
a pulse duration of a laser pulse is between 50 fs and 10 ps and/or
a plurality of laser pulses are emitted in a pulse train, a repetition rate of the laser pulses in the pulse train being between 1 kHz and 50 GHz, and/or
individual laser pulses are emitted, a repetition rate of the individual laser pulses being between 1 kHz and 50 MHz, and/or
a numerical aperture of the focused laser beam is between 0.1 and 0.7, and/or
a fluence at the focus is greater than 0.01 J/cm², and/or
a raw beam diameter preferably has a magnitude of 5 mm, and/or
a average laser power is between 0.5 W and 50 W.

13. The method as claimed in claim 1, wherein a laser pulse energy is temporally modulated from pulse to pulse with a modulation rate being between 100 Hz and 10 kHz, and a modulation shape preferably being sine-shaped or triangular.

14. The method as claimed in claim 1, wherein the ultrashort laser pulses of the laser beam are introduced into the material together with a further laser beam that is a continuous-wave laser beam or carrying pulses having a pulse length of between 1 ns and 100 us.

15. The method as claimed in claim 1, wherein the laser beam and the joining partners are moved and/or positioned relative to one another.

16. A device for joining two joining partners, comprising
an ultrashort pulse laser configured to emit a laser beam carrying ultrashort laser pulses,
an advancing device configured to shift and/or position the joining partners and the laser beam relative to one another,
a focusing optical unit configured to generate an intensity boost of the laser beam, the focusing optical unit comprising a beam shaping optical unit configured to impose on the laser beam a focus zone elongated in a direction of beam propagation,
wherein the ultrashort laser pulses of the laser beam of the ultrashort pulse laser configured to join the to joining partners,
wherein at least one joining partner is substantially transparent to the ultrashort laser pulses of the ultrashort pulse laser, and
at least one of the joining partners includes a coating on a surface arranged intended to join with another of the two joining partners,
wherein the coating comprises physical properties similar to at least one joining partner and/or a chemical constituent similar to at least one joining partner.

17. The device as claimed in claim 16, wherein the focusing optical unit comprises a distance sensor configured to regulate a distance and/or a positioning of the joining partners relative to a reference point in space.

18. The device as claimed in claim 16, wherein the focusing optical unit comprises a camera configured to regulate an establishing of the laser focus.
